(19) United States
(12) Patent Application Publication
(10) Pub. No.: US 2015/0131621 A1
(43) Pub. Date: May 14, 2015

(54) FAST OUTER-LOOP POWER CONTROL

(71) Applicant: QUALCOMM Incorporated, San Diego, CA (US)

(72) Inventors: Shashank Vishwanatha Maiya, Sunnyvale, CA (US); Roee Cohen, Kibbutz Eyal (IL); Nate Chizgi, Sunnyvale, CA (US); Sharif Ahsanul Matin, San Diego, CA (US)

(73) Assignee: QUALCOMM Incorporated, San Diego, CA (US)

(21) Appl. No.: 14/253,305

(22) Filed: Apr. 15, 2014

Related U.S. Application Data
(60) Provisional application No. 61/901,975, filed on Nov. 8, 2013.

(51) Int. Cl. H04W 52/12; H04W 72/04; H04W 52/24

(52) U.S. Cl. CPC H04W 52/12; H04W 52/241; H04W 72/0446; H04W 72/0473
USPC 370/336; 370/329

(57) ABSTRACT

A signal-to-interference target is adjusted multiple times within a transmission time interval. For example, the signal-to-interference target may be adjusted at the slot level. According to some aspects of the disclosure, the signal-to-interference target may be adjusted based on early detection of the transport format being transmitted by the network. For example, the signal-to-interference target may be quickly adjusted at each slot upon detection of the kind of transport format present during that slot. Advantageously, such an approach may reduce the transient time that it takes for the signal-to-interference target to be updated to a new transport format.

### CROSS-REFERENCE TO RELATED APPLICATION

This application claims priority to and the benefit of provisional patent application no. 61/901,975 filed in the U.S. patent office on Nov. 8, 2013, the entire content of which is incorporated herein by reference.

### TECHNICAL FIELD

Aspects of the present disclosure relate generally to wireless communication systems, and more particularly, but not exclusively, to controlling transmit power.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

UMTS networks may utilize transmit power control (TPC) algorithms to control the transmit power on one or more channels. For example, an outer loop power control (OLPC) algorithm may monitor errors associated with received traffic and adjust a signal-to-interference ratio (SIR) target used by an inner loop power control (ILPC) algorithm so that a particular block error rate (BLER) target for the received traffic is met. In practice, conventional OLPC may have several drawbacks. For example, the BLER seen across different channels may be different. In addition, the OLPC algorithm may take an inordinate amount of time to update the SIR target. Therefore, there is a desire to improve transmit power control in wireless networks.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the present disclosure provide for adjusting a signal-to-interference target multiple times within a transmission time interval. For example, the signal-to-interference target may be adjusted at the slot level. According to some aspects of the disclosure, the signal-to-interference target may be adjusted based on early detection of the transport format being transmitted by the network. For example, the signal-to-interference target may be quickly adjusted at each slot upon detection of the kind of transport format present during that slot. Advantageously, such an approach may reduce the transient time that it takes for the signal-to-interference target to be updated to a new transport format.

In some aspects, a first algorithm involves maintaining a single SIR target (SIRT), designated SIRT_{OLPC}, at the OLPC. The ILPC generates the downlink (DL) TPC bit based on another SIRT, designated SIRT_{ILPC}, which may be offset relative to the SIRT maintained at the OLPC. SIRT_{ILPC} is dependent on the transport format that is being transmitted on the downlink. The OLPC maintains SIRT_{OLPC} in a manner that achieves a certain target BLER for full rate transport format in transport channel A. For example, the OLPC can increase the SIRT_{OLPC} by a first delta if all the transport formats fail CRC, and decrease the SIRT_{OLPC} by a second delta if any of the transport formats pass CRC.

In some aspects, a second algorithm involves maintaining multiple SIRTs at the OLPC. For example, the second algorithm may attempt to ensure that the target BLER converges across multiple transport formats in a transport channel by maintaining individual SIRTs for each transport format. In an example implementation, the OLPC maintains three SIRTs: SIRT_{FR} for full rate (FR) transport format, SIRT_{SID} for a silent mode (SID) transport format, and SIRT_{NULL} for null transport format. The ILPC then generates the DL TPC bit based on a classifier decision on the transmitted transport format and based on the corresponding SIRT.

Further to the above, in one aspect, the disclosure provides a method for transmit power control including receiving a signal during a transmission time interval; generating a plurality of signal-to-interference ratio targets based on the received signal; generating a plurality of signal-to-interference values based on the received signal; and generating a plurality of transmit power control commands based on the generated signal-to-interference ratio targets and the generated signal-to-interference values.

Another aspect of the disclosure provides an apparatus configured for transmit power control. The apparatus including means for receiving a signal during a transmission time interval; means for generating a plurality of signal-to-interference ratio targets based on the received signal; means for generating a plurality of signal-to-interference values based on the received signal; and means for generating a plurality of transmit power control commands based on the generated signal-to-interference ratio targets and the generated signal-to-interference values.

Another aspect of the disclosure provides an apparatus for transmit power control that includes at least one processor and a memory coupled to the at least one processor. The at least one processor is configured to receive a signal during a transmission time interval; generate a plurality of signal-to-interference ratio targets based on the received signal; generate a plurality of signal-to-interference values based on the received signal; and generate a plurality of transmit power control commands based on the generated signal-to-interference ratio targets and the generated signal-to-interference values.

Another aspect of the disclosure provides non-transitory computer-readable medium having instructions for causing a computer to receive a signal during a transmission time interval; generate a plurality of signal-to-interference ratio targets based on the received signal; generate a plurality of signal-to-interference values based on the received signal; and generate a plurality of transmit power control commands based on the generated signal-to-interference ratio targets and the generated signal-to-interference values.

Another aspect of the disclosure provides a method for transmit power control including receiving a signal during a plurality of transmission time intervals; and generating a plurality of signal-to-interference ratio targets for each of the transmission time intervals based on the received signal.

Another aspect of the disclosure provides an apparatus configured for transmit power control. The apparatus including means for receiving a signal during a plurality of transmission time intervals; and means for generating a plurality of signal-to-interference ratio targets for each of the transmission time intervals based on the received signal.

Another aspect of the disclosure provides an apparatus for transmit power control that includes at least one processor and a memory coupled to the at least one processor. The at least one processor is configured to receive a signal during a plurality of transmission time intervals; and generate a plurality of signal-to-interference ratio targets for each of the transmission time intervals based on the received signal.

Another aspect of the disclosure provides non-transitory computer-readable medium having instructions for causing a computer to receive a signal during a plurality of transmission time intervals; and generate a plurality of signal-to-interference ratio targets for each of the transmission time intervals based on the received signal.

These and other aspects of the disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a conceptual diagram illustrating an example of a network environment in which one or more aspects of the present disclosure may find application.

FIG. 2 is a block diagram illustrating an example of a communication system in which one or more aspects of the disclosure may find application.

FIG. 3 is a conceptual diagram illustrating an example of a radio protocol architecture for a user plane and a control plane.

FIG. 4 is a block diagram illustrating an example of a communication system where an access terminal is configured for transport format-based power control in accordance with some aspects of the disclosure.

FIG. 5 is a block diagram illustrating select components of an apparatus configured to provide transport format-based power control in accordance with some aspects of the disclosure.

FIG. 6 is a flowchart illustrating a method of transmit power control in accordance with some aspects of the disclosure.

FIG. 7 is a flowchart illustrating a method of generating SIR targets in accordance with some aspects of the disclosure.

FIG. 8 is a flowchart illustrating a method of generating SIR targets in accordance with some aspects of the disclosure.

FIG. 9 is a block diagram illustrating select components of an apparatus configured to provide transport format-based power control in accordance with some aspects of the disclosure.

FIG. 10 is a flowchart illustrating a method of transmit power control in accordance with some aspects of the disclosure.

FIG. 11 is a flowchart illustrating a method of generating a transmit power control command in accordance with some aspects of the disclosure.

FIG. 12 is a block diagram illustrating select components of an apparatus configured to provide transport format-based power control in accordance with some aspects of the disclosure.

FIG. 13 is a block diagram illustrating an example of a base station in communication with an access terminal in a communication network.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

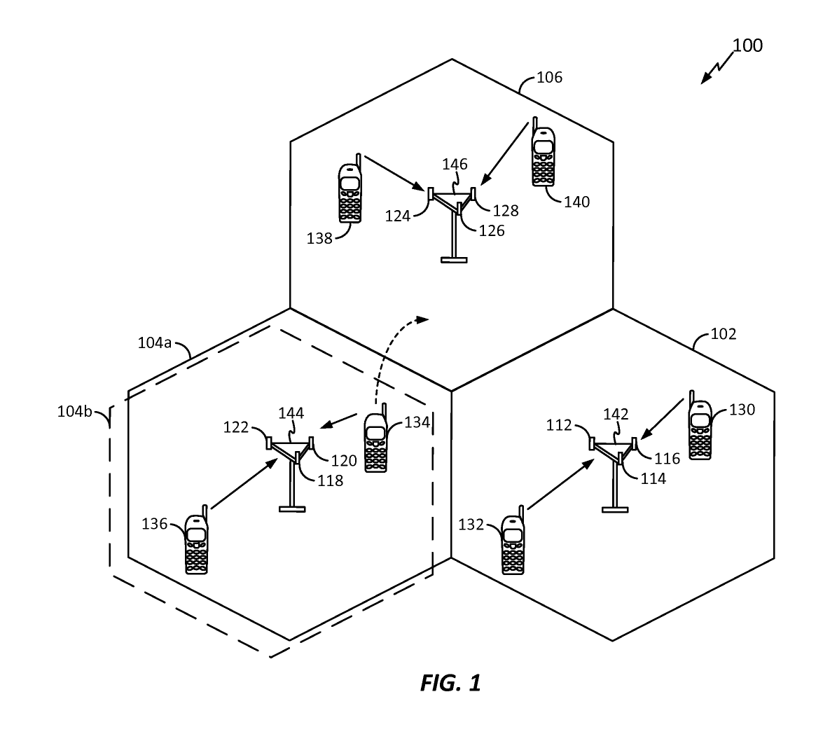

The various concepts presented throughout this disclosure may be implemented across a broad variety of telecommunication systems, network architectures, and communication standards. Referring to FIG. 1, by way of example and without limitation, a simplified access network 100 in a UMTS Terrestrial Radio Access Network (UTRAN) architecture, which may utilize High-Speed Packet Access (HSPA), is illustrated. The system includes multiple cellular regions (cells), including cells 102, 104, and 106, each of which may include one or more sectors. Cells may be defined geographically, e.g., by coverage area, and/or may be defined in accordance with a frequency, scrambling code, etc. That is, the illustrated geographically-defined cells 102, 104, and 106 may each be further divided into a plurality of cells, e.g., by utilizing different frequencies or scrambling codes. For example, cell 104a may utilize a first frequency or scrambling code, and cell 104b, while in the same geographic region and served by the same Node B 144, may be distinguished by utilizing a second frequency or scrambling code.

In a cell that is divided into sectors, the multiple sectors within a cell can be formed by groups of antennas with each antenna responsible for communication with UEs in a portion of the cell. For example, in cell 102, antenna groups 112, 114, and 116 may each correspond to a different sector. In cell 104, antenna groups 118, 120, and 122 each correspond to a different sector. In cell 106, antenna groups 124, 126, and 128 each correspond to a different sector.

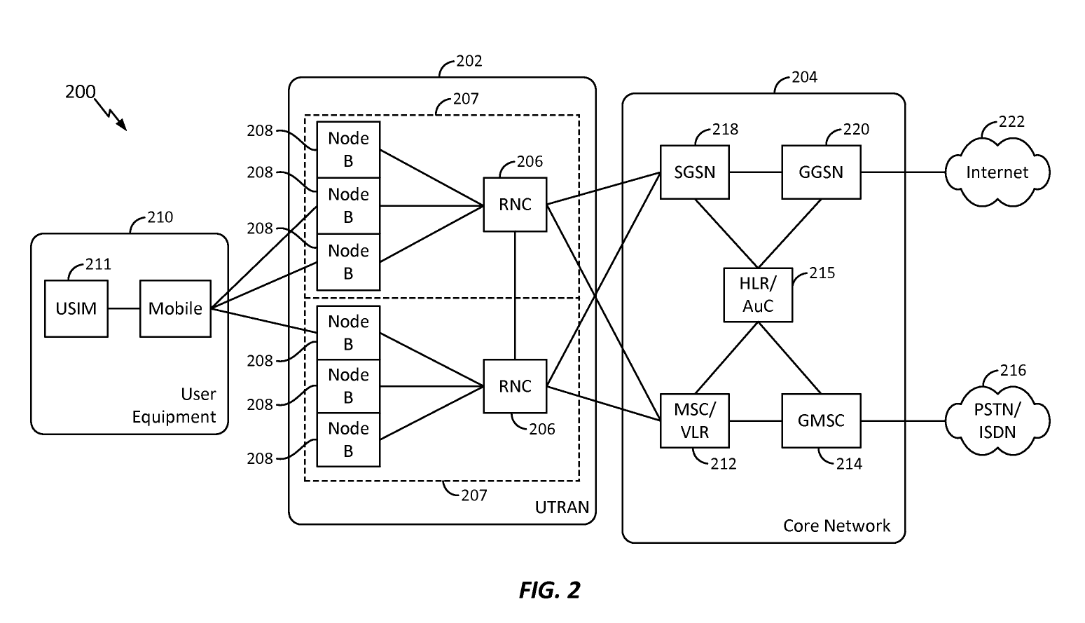

The cells 102, 104 and 106 may include several UEs that may be in communication with one or more sectors of each cell 102, 104 or 106. For example, UEs 130 and 132 may be in communication with Node B 142, UEs 134 and 136 may be in communication with Node B 144, and UEs 138 and 140 may be in communication with Node B 146. Here, each Node B 142, 144, 146 is configured to provide an access point to a core network 204 (see FIG. 2) for all the UEs 130, 132, 134, 136, 138, 140 in the respective cells 102, 104, and 106.

Referring now to FIG. 2, by way of example and without limitation, various aspects of the present disclosure are illustrated with reference to a Universal Mobile Telecommunications System (UMTS) system 200 employing a wideband code division multiple access (W-CDMA) air interface. A UMTS network includes three interacting domains: a Core Network (CN) 204, a UMTS Terrestrial Radio Access Network (UTRAN) 202, and User Equipment (UE) 210. In this example, the UTRAN 202 may provide various wireless services including telephony, video, data, messaging, broadcasts, and/or other services. The UTRAN 202 may include a plurality of Radio Network Subsystems (RNSs) such as the illustrated RNSs 207, each controlled by a respective Radio Network Controller (RNC) such as an RNC 206. Here, the UTRAN 202 may include any number of RNCs 206 and RNSs 207 in addition to the illustrated RNCs 206 and RNSs 207. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a core network (CN) 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210, and the uplink (UL), also called the reverse link, refers to the communication link from a UE 210 to a Node B 208.

The core network 204 interfaces with one or more access networks, such as the UTRAN 202. As shown, the core network 204 is a GSM core network. However, as those skilled in the art will recognize, the various concepts presented throughout this disclosure may be implemented in a RAN, or other suitable access network, to provide UEs with access to types of core networks other than GSM networks.

The illustrated GSM core network 204 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains.

In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The illustrated core network 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

The UMTS air interface may be a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such DS-CDMA technology and additionally calls for a frequency division duplexing (FDD). FDD uses a different carrier frequency for the uplink (UL) and downlink (DL) between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles are equally applicable to a TD-SCDMA air interface.

A high speed packet access (HSPA) air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

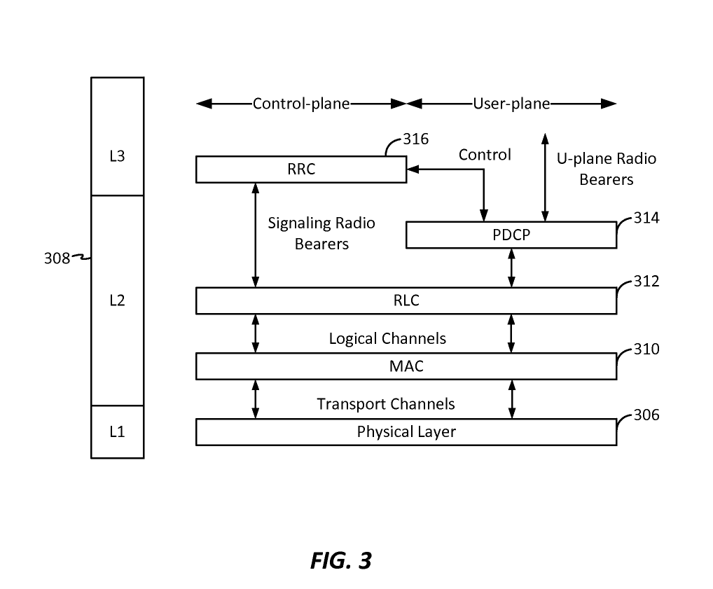

In a wireless telecommunication system, the radio protocol architecture between a mobile device and a cellular network may take on various forms depending on the particular application. An example for a 3GPP high-speed packet access (HSPA) system will now be presented with reference to FIG. 3, illustrating an example of the radio protocol architecture for the user and control planes between the UE 210 and the Node B 208. Here, the user plane or data plane carries user traffic, while the control plane carries control information, i.e., signaling.

Turning to FIG. 3, the radio protocol architecture for the UE 210 and Node B 208 is shown with three layers: Layer 1, Layer 2, and Layer 3. Although not shown, the UE 210 may have several upper layers above the L3 layer including a network layer (e.g., IP layer) that is terminated at a PDN gateway on the network side, and an application layer that is terminated at the other end of the connection (e.g., far end UE, server, etc.).

At Layer 3, the RRC layer 316 handles control plane signaling between the UE 210 and the Node B 208. RRC layer 316 includes a number of functional entities for routing higher layer messages, handling broadcast and paging functions, establishing and configuring radio bearers, etc.

The data link layer, called Layer 2 (L2 layer) 308 is between Layer 3 and the physical layer 306, and is responsible for the link between the UE 210 and Node B 208. In the illustrated air interface, the L2 layer 308 is split into sublayers. In the control plane, the L2 layer 308 includes two sublayers: a medium access control (MAC) sublayer 310 and a radio link control (RLC) sublayer 312. In the user plane, the L2 layer 308 additionally includes a packet data convergence protocol (PDCP) sublayer 314. Of course, those of ordinary skill in the art will comprehend that additional or different sublayers may be utilized in a particular implementation of the L2 layer 308, still within the scope of the present disclosure.

The PDCP sublayer 314 provides multiplexing between different radio bearers and logical channels. The PDCP sublayer 314 also provides header compression for upper layer data packets to reduce radio transmission overhead, security by ciphering the data packets, and handover support for UEs between Node Bs.

The RLC sublayer 312 provides segmentation and reassembly of upper layer data packets, retransmission of lost data packets, and reordering of data packets to compensate for out-of-order reception due to a hybrid automatic repeat request (HARQ).

The MAC sublayer 310 provides multiplexing between logical channels and transport channels. The MAC sublayer 310 is also responsible for allocating the various radio resources (e.g., resource blocks) in one cell among the UEs. The MAC sublayer 310 is also responsible for HARQ operations.

Layer 1 is the lowest layer and implements various physical layer signal processing functions. Layer 1 will be referred to herein as the physical layer (PHY) 306. At the PHY layer 306, the transport channels are mapped to different physical channels.

Data generated at higher layers, all the way down to the MAC layer 310, are carried over the air through transport channels. 3GPP Release 5 specifications introduced downlink enhancements referred to as HSDPA. HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries HARQ ACK/NACK signaling on the uplink to indicate whether a corresponding packet transmission was decoded successfully. That is, with respect to the downlink, the UE 210 provides feedback to the Node B 208 over the HS-DPCCH to indicate whether it correctly decoded a packet on the downlink.

HS-DPCCH further includes feedback signaling from the UE 210 to assist the Node B 208 in taking the right decision in terms of modulation and coding scheme and precoding weight selection, this feedback signaling including the channel quality indicator (CQI) and precoding control information (PCI).

3GPP Release 6 specifications introduced uplink enhancements referred to as Enhanced Uplink (EUL) or High Speed Uplink Packet Access (HSUPA). HSUPA utilizes as its transport channel the EUL Dedicated Channel (E-DCH). The E-DCH is transmitted in the uplink together with the Release 99 DCH. The control portion of the DCH, that is, the DPCCH, carries pilot bits and downlink power control commands on uplink transmissions. In the present disclosure, the DPCCH may be referred to as a control channel (e.g., a primary control channel) or a pilot channel (e.g., a primary pilot channel) in accordance with whether reference is being made to the channel's control aspects or its pilot aspects.

The E-DCH is implemented by physical channels including the E-DCH Dedicated Physical Data Channel (E-DPDCH) and the E-DCH Dedicated Physical Control Channel (E-DPCCH). In addition, HSUPA relies on additional physical channels including the E-DCH HARQ Indicator Channel (E-HICH), the E-DCH Absolute Grant Channel (E-AGCH), and the E-DCH Relative Grant Channel (E-RGCH). Further, in accordance with aspects of the present disclosure, for HSUPA with MIMO utilizing two transmit antennas, the physical channels include a Secondary E-DPDCH (S-E-DPDCH), a Secondary E-DPCCH (S-E-DPCCH), and a Secondary DPCCH (S-DPCCH).

Thus, UMTS networks utilize a channel structure whereby logical channels (e.g., logical control and traffic channels for uplink and downlink traffic) are mapped to transport channels which are, in turn, mapped to the physical channels. Different frame structures, coding, and operating modes may be deployed depending on, for example, the traffic being carried and deployments decisions.

### Transmit Power Control

UMTS networks may utilize transmit power control algorithms to control the transmit power on one or more channels. For example, an outer loop power control (OLPC) algorithm may monitor errors associated with received traffic and adjust a signal-to-interference ratio (SIR) target used by an inner loop power control (ILPC) algorithm so that a particular block error rate (BLER) target for the received traffic is met. In a typical implementation, the OLPC algorithm performs a cyclic redundancy check (CRC) on the traffic received over a designated transmission time interval (TTI). In this case, once every TTI (e.g., every 20 ms), the OLPC algorithm increases the SIR target (SIRT) if the error rate is greater than a target error rate (e.g., a target BLER) or decreases the SIRT if the error rate is lower than a target error rate.

The ILPC algorithm controls transmit power based on the SIR of received traffic. To this end, the ILPC algorithm compares the SIR of the received traffic with the current SIRT. If the SIR is lower than the SIRT, the ILPC algorithm generates a transmit (transmission) power control (TPC) bit that instructs the node that transmitted the traffic to increase its transmit power. Conversely, if the SIR is higher than the SIRT, the ILPC algorithm generates a TPC bit that instructs the node that transmitted the traffic to decrease its transmit power. Thus, the ILPC and OLPC algorithms cooperate to ensure that sufficient transmit power is being used to achieve a desired BLER, while ensuring that the network resources are being used and shared efficiently by restricting the transmit power level so that it does not significantly exceed the power level needed to meet the BLER target.

The manner in which transit power control operates for a given implementation may depend, in some aspects, on the type of traffic being carried over a channel and the configuration of that channel. For example, for voice traffic, adaptive multi-rate (AMR) data may be carried over a transport channel. The OLPC algorithm maintains SIR targets to ensure that the desired BLER target is met for all such transport channels, provided the transport channels are eligible for this power control.

Transport channels that are not eligible include transport channels that do have CRC bits enabled and, under certain conditions, transport channels where blind transport format detection (BTFD) is employed. As an example of the former case, for AMR traffic, transport channel B (TrCh B) and transport channel C (TrCh C) are not eligible. As an example of the latter case, a transport channel in BTFD mode is not eligible if at least one of the transport formats for the channel has a zero length transport block. For AMR Traffic, dedicated control channel (DCCH) transport channel with transport format (TF) set to {0×148, 1×148} is not eligible.

Table 1 summarizes an example of a frame structure and transport channel combinations for AMR 12.2 k on Slot Format 8 with RM (rate matching) attributes of {180, 175, 234, 180}.

TABLE 1

| | Transport | Transport | | |
|---|---|---|---|---|
| | Channel (TrCh) | Format Set | TTI | CRC Length |
| AMR, Class | TrCh A | 1 × 0 | 20 ms | 12 |
| A | | 1 × 39 | | |
| | | 1 × 81 | | |
| AMR, Class | TrCh B | 0 × 103 | 20 ms | 0 |
| B | | 1 × 103 | | |
| AMR, Class | TrCh C | 0 × 60 | 20 ms | 0 |
| C | | 1 × 60 | | |
| SRB | DCCH TrCh | 0 × 148 | 40 ms | 16 |
| | | 1 × 148 | | |

From Table 1 and the discussion above, it may be seen that, for AMR traffic with DCCH transport format set to {0×148, 1×148} and operating in BTFD mode, the only eligible channel that participates in OLPC is transport channel A (TrCh A).

The transport channel A SIRT is designed to take a value that ensures that the BLER rate on transport channel A converges to a desired target BLER, designated “t %” for convenience. As indicated in Table 1, transport channel A in AMR single rate codec has 3 transport formats: NULL (1×0), SID (1×39), and FR (1×81). Here, SID corresponds to a silent mode and FR corresponds to a full rate mode. OLPC maintains one SIRT (corresponding to transport channel A) such that: 1) the SIRT is increased by x dB if all the transport formats fail CRC; and 2) the SIRT is decreased by y dB if any of the transport formats pass CRC. By appropriately selecting (x, y) dB, one may ensure that the target BLER converges to t %. Typically, y<x dB. Thus, it takes more time for the OLPC to decrease the SIRT than to increase the SIRT.

In practice, conventional OLPC may have several drawbacks.

First, the BLER seen across different transport channels may be different. Target BLER t % is guaranteed across all transport formats in transport channel A. That is, BLER is controlled so that the number of BLER on {NULL, SID and FR}/Total Number of transport channel A TTIs*100 is equal to t %. However, NULL transport format requires the lowest power and FR transport format requires the highest power to achieve a desired BLER % for a given channel condition. As a result, though the algorithm would have converged to t % BLER for transport channel A, the BLER % seen on NULL<the BLER % seen on SID, while the BLER % seen on SID<the BLER % seen on FR.

Second, the OLPC algorithm may take an inordinate amount of time to update the SIRT. During voice transitions there are two kinds of voice activities: 1) voice activity, where the transmitted transport format is only FR; and 2) silent activity, where the transmitted transport format typically includes a pattern of {7 NULL, 1 SID}. Considering a realistic example where the operating BLER is 1%, (x, y) dB=(0.5, 0.5/99) dB and operating SIRT to achieve 1%; BLER for NULL and SID are 1.5 dB and 0.5 dB lower than for FR, respectively.

For a transition from voice activity to silent activity, operating SIRT would correspond to FR transport format (which is 1.5 dB higher than NULL). Hence, it would take around 297 TTIs (0.55/99 dB per TTI) to reach the SIRT corresponding to NULL transport format.

For a transition from silent activity to voice activity, operating SIRT would correspond to NULL transport format (which is 1.5 dB lower than FR). Hence, it would take around 3 TTIs to reach the 1% SIRT for FR.

Moreover, during these transitions, there may be additional FR transport formats with CRC errors and additional NULL transport formats where CRC passes.

Summarizing the above, for single rate AMR calls in BTFD mode with DCCH transport format {0×148, 1×148}, a conventional OLPC implementation maintains a single SIRT for transport channel A which is used to achieve desired QOS (a specific target BLER). However, such a scheme is subject to varying BLER rates across the different transport formats in transport channel A and increased power consumption during voice activity transitions.

### Transport Format-Based TPC

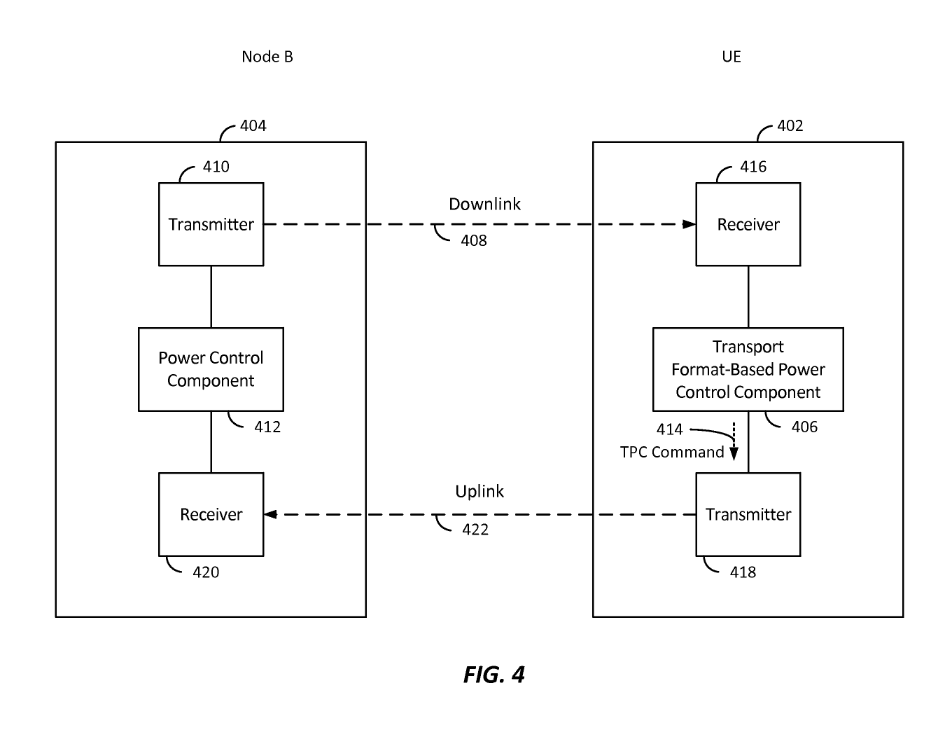

Referring now to FIGS. 4-11, various aspects of a power control scheme according to the present disclosure are presented. For purposes of illustration, and without limitation, these aspects of the disclosure may be described in the context of a UMTS-based network where a Node B serves a user equipment (UE). It should be appreciated that the disclosed aspects may be applicable to other types of apparatuses and other technology.

FIG. 4 illustrates an example where a UE 402 served by a Node B 404 employs a transport format-based power control (TFPC) component 406 to control the transmit power on a downlink 408. It should be appreciated that the Node B 404 (e.g., for uplink power control), or any other suitable apparatus, could employ transport format-based power control in accordance with the teachings herein.

A transmitter 410 of the Node B 404 transmit signals on the downlink 408 according to a transmit power specified by a power control component 412. As discussed below, this transmit power is set based on a TPC command 414 sent by the UE 402.

A receiver 416 of the UE 402 receives the signals on the downlink 408 and provides the signals to the TFPC component 406. The TFPC component 406 determines a BLER associated with the received signals and, through the use of OLPC and ILPC, generates the TPC command 414 based on this BLER. A transmitter 418 of the UE 402 sends the TPC command 414 to a receiver 420 of the Node B via an uplink 422. Upon receipt of the TPC command 414, the power control component 412 adjusts the transmit power of the transmitter 410. Accordingly, transmit power of the transmitter 410 is controlled to maintain a desired BLER at the receiver 416.

In the example, of FIG. 4, the TFPC component 406 performs OLPC and ILPC to generate the TPC command 414. In accordance with the teachings herein, the ILPC is based, at least in some aspects, on the transport format of the received signals. Two examples of algorithms that may be employed to provide transport format-based power control follow.

### First Algorithm

The first algorithm involves maintaining a single SIRT, designated SIRT_{OLPC}, at the OLPC. The ILPC generates the downlink (DL) TPC bit based on another SIRT, designated SIRT_{ILPC}, which may be offset relative to the SIRT maintained at the OLPC. SIRT_{ILPC} is dependent on the transport format that is being transmitted on the downlink.

The OLPC maintains SIRT_{OLPC} in a manner that achieves t % target BLER for FR transport format in transport channel A. For example, as discussed above, the OLPC can increase the SIRT_{OLPC} by x dB if all the transport formats fail CRC, and decrease the SIRT_{OLPC} by y dB if any of the transport formats pass CRC.

For every slot in a TTI, the following three operations are performed.

First, the algorithm invokes a classification algorithm to detect the transport channel A transport format for the slot as quickly as possible. In some classification algorithms, classification of a transport channel early on in a TTI might not be accurate. However, such a classification algorithm may generate more accurate estimates of the type of transport format as more estimations are subsequently made later in the TTI. Thus, in some aspects, such a classification will eventually converge to an accurate transport format estimate later on in the TTI. An example of such a classification algorithm is described in U.S. Provisional Application No. 61/842,824, filed Jul. 3, 2013.

Second, the algorithm adjusts the local SIRT based on the results of the classification. If the transport format=NULL, SIRT_{ILPC} is set to a value equal to SIRT_{OLPC} decreased by an offset, designated, δ_{NULL}. Thus, SIRT_{ILPC}=SIRT_{OLPC}−δ_{NULL} in this case. If the transport format=SID, SIRT_{ILPC} is set to a value equal to SIRT_{OLPC} decreased by an offset, designated, δ_{SID}. Thus, SIRT_{ILPC}=SIRT_{OLPC}−δ_{SID} in this case. If the transport format=FR, no offset is applied. Thus, SIRT_{ILPC}=SIRT_{OLPC} in this case.

Third, the algorithm generates a DL TPC command, such as a TPC bit, based on the SIRT_{ILPC}. For example, the SIR of a received signal is compared to the SIRT_{ILPC}. Based on the results of this comparison, the algorithm generates a TPC command specifying an increase or decrease in transmit power.

The algorithm then repeats the above three operations for the next slot. For example, the algorithm may wait for an updated classifier result to be generated for the next slot and then repeat the process.

Several aspect of the first algorithm may be noted. First, use of the algorithm does not change the manner in which SIRT_{OLPC} is calculated. Second, the SIRT used by the ILPC (SIRT_{ILPC}) to generate the DL TPC bit is an offset from the SIRT_{OLPC}, except for the FR case. Third, each offset is fixed and the offset selected is only dependent on the detected transport format. However, a UE may determine the offset at the beginning of DCH state, or at every reconfiguration within DCH state based on available transport channels as well as rate matching RM parameters associated with them. For example, at the onset of every call (start of DCH state), the UE may determine how many transport channels are available for the call (e.g., the call can be merely a voice call incurring 3+1=4 transport channels; or it can be a multi radio access bearer (RAB) call with an R99 packet switched (PS) call incurring (3+1+1)=5 transport channels; or a multi RAB call with high speed (HS) incurring (3+1)=4 transport channels, etc.) and determine the appropriate rate matching parameters. The UE can then determine the offset based on this information. Fourth, the SIRT converges to SIRTₜ, SIRTₜ−δ_{SID}, and SIRTₜ−δ_{NULL} for FR transport format, SID transport format, and NULL transport format, respectively. Here SIRTₜ is the OLPC SIRT which is designed to ensure t % target BLER on FR transport format. While the above aspects were employed in the first algorithm described above, it should be appreciated that the first algorithm may be adapted in accordance with the teachings herein whereby the above aspects need not be applied in every implementation of the first algorithm.

The first algorithm may be modified to account for the type of traffic being carried on a transport channel. For example, additional detectors such as a dedicated control channel (DCCH) detector can be added to ensure that DCCH performance is not adversely affected. In such a case, the algorithm may be configured to not change the SIRT_{ILPC} in the event DCCH is detected, regardless of the transport channel A transport format.

Advantageously, the first algorithm may achieve performance gains over a conventional OLPC algorithm. For example, according to a simulation, use of the first algorithm may result in E_{C}I_{OR} gains and/or lower BLER.

In some implementations, an exit mechanism is employed to cease use of the ILPC SIRT(s) or to force recomputation of the ILPC SIRT(s) under certain conditions. For example, a UE may monitor the BLER across different transport formats over a certain period of time. If the BLER is too high or too low for a given transport format, then either that transport format may be exempted from the use of the ILPC SIRT(s) (i.e., the UE will go back to using the SIRT specified by the OLPC) or the δ computations may be performed again. As one non-limiting example, a masking of +/−30% experienced BLER compared to the assigned target BLER for the whole transport channel could be used as a potential boundary. That is, for a given transport format, the algorithm might not be employed beyond this limit. Accordingly, in some aspects, a UE may discontinue maintaining or imposing SIRT_{ILPC} if the BLER for a certain transport format exceeds a boundary measured over a given period of time. Alternatively, the UE may recompute the SIRT Offset for the transport formats and use the newly computed values going forward.

In some implementations, an OLPC adjustment factor may be based on the following equation:

$$0.5 dB * \frac{\frac{n}{N} - {BLER}_{i}}{1 - {BLER}_{i}} * \frac{N}{{N}_{max}}$$

In some implementations, n, N and Nₘₐₓ are all equal to 1 (e.g., for voice).

In some implementations, the ratio of “the existing symbols of a transport format” over “the maximum possible symbols for full rate (FR)” (both after rate matching) are used for the last term N/Nₘₐₓ. In some aspects, this may involve mapping the SIRT increment/decrement by using a linear mapping based on the rate matched symbols across different transport formats. The number of symbols might thus be one parameter that can be used to assess the SIRT offset in accordance with the teachings herein. It should be appreciated, however, that other types of parameters also may be used to assess the SIRT offset in accordance with the teachings herein. In view of the above, in some aspects, SIRT offsets might be computed based on rate matched symbols across different transport formats of each transport channel. In addition, such scaling can also be applied to determining SIRT_{OLPC} in some implementations.

### Second Algorithm

The second algorithm mentioned above involves maintaining multiple SIRTs at the OLPC. In accordance with some aspects of the disclosure, the second algorithm attempts to ensure that the target BLER converges across multiple transport formats in a transport channel by maintaining individual SIRTs for each transport format. In an example implementation, the OLPC maintains three SIRTs; one for each transport format: SIRT_{FR}, SIRT_{SID}, and SIRT_{NULL}. The ILPC then generates the DL TPC bit based on a classifier decision on the transmitted transport format and based on the corresponding SIRT.

The OLPC maintains SIRT_{FR}, SIRT_{SID}, and SIRT_{NULL} in a manner that attempts to achieve t % target BLER for FR transport format, SID transport format, and NULL transport format, respectively. For example, the OLPC can increase the SIRT_{FR} by x dB if all the FR transport formats fail CRC, and decrease the SIRT_{FR} by y dB if any of the FR transport formats pass CRC. Similarly, the OLPC can increase the SIRT_{SID} by x dB if all the SID transport formats fail CRC, and decrease the SIRT_{SID} by y dB if any of the SID transport formats pass CRC. Also, the OLPC can increase the SIRT_{NULL} by x dB if all the NULL transport formats fail CRC, and decrease the SIRT_{NULL} by y dB if any of the NULL transport formats pass CRC.

For every slot in a TTI, the following two operations are performed.

First, the algorithm invokes a classification algorithm to detect the transport channel A transport format for the slot as quickly as possible. This classification is similar to the classification described above with reference to the first algorithm.

Second, the algorithm generates a DL TPC command, such as a TPC bit, based on the SIRT corresponding to the early detected transport format. If the transport format detected for the slot=NULL, the SIR of a received signal is compared to the SIRT_{NULL}. If the transport format detected for the slot=SID, the SIR of a received signal is compared to the SIRT_{SID}. If the transport format detected for the slot=FR, the SIR of a received signal is compared to the SIRT_{FR}. Based on the results of this comparison, the algorithm generates a TPC command specifying an increase or decrease in transmit power.

The algorithm then repeats the above two operations for the next slot of the TTI. For example, the algorithm may wait for an updated classifier result to be generated for the next slot and then repeat the process.

At the end of the TTI, the following two operations are performed.

First, the OLPC obtains the results of the CRC operation over the TTI. For example, a utility such as Demback could be employed to decode the transport channel and run a CRC check on the information received during the TTI.

Second, the appropriate one of the SIRTs is adjusted based on the CRC results for the TTI. If the transport format of the TTI is NULL, SIRT_{NULL} is adjusted. If the transport format of the TTI is SID, SIRT_{SID} is adjusted. If the transport format of the TTI is FR, SIRT_{FR} is adjusted.

As mentioned above, the manner in which the SIRT is adjusted may depend on whether the transport format passed or failed CRC. SIRT_{F} may be decreased by y dB, where F corresponds to the transport format that just passed the CRC (e.g., FR transport format, SID transport format, or NULL transport format). SIRT_{F} may be increased by x dB, where F corresponds to the transport format that just failed the CRC (e.g., FR transport format, SID transport format, or NULL transport format). The transport format that failed CRC may be identified, for example, based on two classifiers generated by the classification algorithm.

The second algorithm is repeated over all TTIs so that eventually all of the SIRTs will be updated. That is, SIRT_{NULL} is updated after a TTI with NULL transport format, SIRT_{SID} is updated after a TTI with SID transport format, and SIRT_{FR} is updated after a TTI with FR transport format. To this end, a different moving average BLER window may be maintained for each transport format.

### Additional Aspects

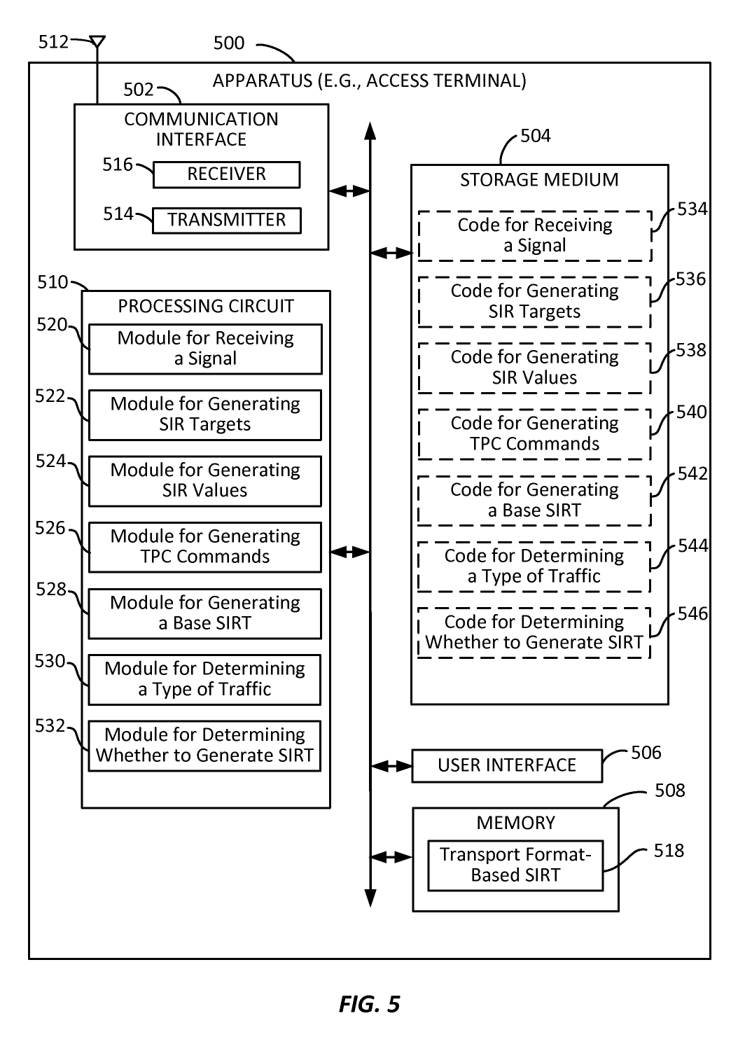

With the above in mind, additional aspects of power control according to the present disclosure will now be described in more detail in conjunction with the FIGS. 5-11. For convenience, any operations described with reference to FIGS. 5-11 (or any other operations discussed or taught herein) may be described as being performed by specific components. It should be appreciated, however, that these operations may be performed by other types of components and may be performed using a different number of components. It also should be appreciated that one or more of the operations described herein may not be employed in a given implementation.

FIG. 5 is an illustration of an exemplary apparatus 500 (e.g., an access terminal) configured according to one or more aspects of the present disclosure. The apparatus 500 includes a communication interface (e.g., at least one transceiver) 502, a storage medium 504, a user interface 506, a memory 508, and a processing circuit 510. These components can be coupled to and/or placed in electrical communication with one another via a signaling bus or other suitable component. In particular, each of the communication interface 502, the storage medium 504, the user interface 506, and the memory 508 are coupled to and/or in electrical communication with the processing circuit 510.

The communication interface 502 may be adapted to facilitate wireless communication of the apparatus 500. For example, the communication interface 502 may include circuitry and/or programming adapted to facilitate the communication of information bi-directionally with respect to one or more communication devices in a network. The communication interface 502 may be coupled to one or more antennas 512 for wireless communication within a wireless communication system. The communication interface 502 can be configured with one or more standalone receivers and/or transmitters, as well as one or more transceivers. In the illustrated example, the communication interface 502 includes a transmitter 514 and a receiver 516.

The memory 508 may represent one or more memory devices. As indicated, the memory 508 may store transport format-based SIRT-related information 518 along with other information used by the apparatus 500. In some implementations, the memory 508 and the storage medium 504 are implemented as a common memory component. The memory 508 may also be used for storing data that is manipulated by the processing circuit 510 or some other component of the apparatus 500.

The storage medium 504 may represent one or more computer-readable, machine-readable, and/or processor-readable devices for storing programming, such as processor executable code or instructions (e.g., software, firmware), electronic data, databases, or other digital information. The storage medium 504 may also be used for storing data that is manipulated by the processing circuit 510 when executing programming. The storage medium 504 may be any available media that can be accessed by a general purpose or special purpose processor, including portable or fixed storage devices, optical storage devices, and various other mediums capable of storing, containing or carrying programming.

By way of example and not limitation, storage medium 504 may comprise a storage device that includes a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, or any other suitable storage device for storing software and/or instructions that may be accessed and read by a computer or a communication device. The storage medium 504 may be embodied in an article of manufacture (e.g., a computer program product). By way of example, a computer program product may include a computer-readable medium in packaging materials. Thus, in some implementations, the storage medium may be a non-transitory (e.g., tangible) storage medium.

The storage medium 504 may be coupled to the processing circuit 510 such that the processing circuit 510 can read information from, and write information to, the storage medium 504. That is, the storage medium 504 can be coupled to the processing circuit 510 so that the storage medium 504 is at least accessible by the processing circuit 510, including examples where at least one storage medium is integral to the processing circuit 510 and/or examples where at least one storage medium is separate from the processing circuit 510 (e.g., resident in the apparatus 500, external to the apparatus 500, distributed across multiple entities).

Programming stored by the storage medium 504, when executed by the processing circuit 510, causes the processing circuit 510 to perform one or more of the various functions and/or process steps described herein. For example, the storage medium 504 may include operations configured for regulating operations at one or more hardware blocks of the processing circuit 510, as well as to utilize the communication interface 502 for wireless communication utilizing their respective communication protocols.

The processing circuit 510 is generally adapted for processing, including the execution of such programming stored on the storage medium 504. As used herein, the term “programming” or the term “code” shall be construed broadly to include without limitation instructions, instruction sets, data, code, code segments, program code, programs, subprograms, software modules, applications, software applications, software packages, routines, subroutines, objects, executables, threads of execution, procedures, functions, programming, etc., whether referred to as software, firmware, middleware, microcode, hardware description language, or otherwise.

The processing circuit 510 is arranged to obtain, process and/or send data, control data access and storage, issue commands, and control other desired operations. The processing circuit 510 may include circuitry configured to implement desired programming provided by appropriate media in at least one example. For example, the processing circuit 510 may be implemented as one or more processors, one or more controllers, and/or other structure configured to execute executable programming. Examples of the processing circuit 510 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 510 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 510 are for illustration and other suitable configurations within the scope of the present disclosure are also contemplated. Also, any of the modules 520-532 of the processing circuit 510 may be arranged or configured in a similar manner. For example, the modules 520-532 may be arranged to obtain, process and/or send data, control data access and storage, issue commands, and control other desired operations; may be configured to implement desired programming; may be implemented as appropriate structure configured to execute executable programming; may be implemented as a combination of computing components or other circuitry; and so on.

According to one or more aspects of the present disclosure, the processing circuit 510 may be adapted to perform any or all of the features, processes, functions, steps and/or routines for any or all of the apparatuses described herein. As used herein, the term “adapted” in relation to the processing circuit 510 may refer to the processing circuit 510 being one or more of configured, employed, implemented, and/or programmed to perform a particular process, function, step and/or routine according to various features described herein.

According to at least one example of the apparatus 500, the processing circuit 510 may include a module for receiving a signal 520, a module for generating SIR targets 522, a module for generating SIR values 524, a module for generating TPC commands 526, a module for generating a base SIRT 528, a module for determining a type of traffic 530, and a module for determining whether to generate SIRT 532.

The module for receiving a signal 520 may include circuitry and/or programming adapted to perform several functions relating to, for example, receiving data during a TTI. One of these functions involves invoking a transfer of specific data from another component. For example, the receiver 516 of the apparatus 500 can be configured to monitor for signals from an access point. Another one of these functions involves acquiring the transferred data. For example, the module for receiving a signal 520 may decode the received signals to derive the data that is encoded in the signals. Another one of these functions involves storing the data for access by another component of the processing circuit 510 or some other component of the apparatus 500. For example, the module for receiving a signal 520 may store the data acquired in the previous function in a specified memory location in the memory 508. In some implementations, the programming referred to above comprises code for receiving a signal 534 stored on the storage medium 504.

The module for generating SIR targets 522 may include circuitry and/or programming adapted to perform several functions relating to, for example, generating a plurality of SIR targets based on a received signal. One of these functions involves acquiring base SIRT. For example, the module for generating SIR targets 522 may retrieve this information from the memory 508 (e.g., passed from an OLPC function). Another one of these functions involves adjusting the base SIRT, if applicable. For example, an SIRT may be based on a type of transport format as discussed herein. Also, an SIRT may be generated for each slot in a TTI. Another one of these functions involves storing an indication of the generated SIRTs. In some implementations, the programming referred to above comprises code for generating SIR targets 536 stored on the storage medium 504.

The module for generating SIR values 524 may include circuitry and/or programming adapted to perform several functions relating to, for example, generating a plurality of SIR values based on a received signal. One of these functions involves acquiring data from the received signal. For example, the module for generating SIR values 524 may obtain this data from the receiver 516. Another one of these functions involves processing the received data to determine a signal to interference level associated with the data. A SIR value may be generated for each slot in a TTI. Another one of these functions involves storing the generated SIR values. In some implementations, the programming referred to above comprises code for generating SIR values 538 stored on the storage medium 504.

Further, the module for generating TPC commands 526 may include circuitry and/or programming adapted to perform several functions relating to, for example, generating TPC commands based on SIRTs and SIR values. One of these functions involves acquiring the SIRTs and the SIR values. For example, the module for generating TPC commands 526 may retrieve this information from the memory 508. Another one of these functions involves processing the acquired information to determine the TPC commands to be issued. For example, the SIR value for a given slot may be compared to the SIRT for that slot. Based on this comparison, a TPC command that indicates that transmit power should be increased or decreased may then be generated. Another one of these functions involves outputting the TPC command. For example, the TPC command may be sent to the transmitter 514 for transmission. In some implementations, the programming referred to above comprises code for generating TPC commands 540 stored on the storage medium 504.

Also, the module for generating a base SIRT 528 may include circuitry and/or programming adapted to perform several functions relating to, for example, generating a base SIRT for a TTI. One of these functions involves determining a block error rate associated with received data. For example, the CRC of received data may be checked. Another one of these functions involves calculating the base SIRT based on the block error rate. For example, as discussed above, a higher error rate may result in a higher SIRT, and vice versa. Another one of these functions involves outputting an indication of the base SIRT (e.g., storing the indication in a specified memory location). In some implementations, the programming referred to above comprises code for generating a base SIRT 542 stored on the storage medium 504.

In addition, the module for determining a type of traffic 530 may include circuitry and/or programming adapted to perform several functions relating to, for example, determining a type of traffic carried by a received signal. For example, upon receipt of data from the receiver 516, the module for determining a type of traffic 530 may process the data to estimate the type of traffic (e.g., DCCH, etc.) associated with the data. This estimation may be performed for each slot within a TTI. Another one of these functions involves outputting an indication of the type of traffic (e.g., storing the indication in a specified memory location). In some implementations, the programming referred to above comprises code for determining a type of traffic 544 stored on the storage medium 504.

Finally, the module for determining whether to generate SIRT 532 may include circuitry and/or programming adapted to perform several functions relating to, for example, determining whether to generate an SIRT by setting the SIRT equal to a base SIRT. One of these functions involves obtaining information regarding the type of traffic associated with a received signal. Another one of these functions involves determining, based on the traffic type, whether to set an SIRT equal to a base SIRT or an offset from the base SIRT. Another one of these functions involves outputting an indication of the SIRT. In some implementations, the programming referred to above comprises code for determining whether to generate SIRT 546 stored on the storage medium 504.

As mentioned above, programming stored by the storage medium 504, when executed by the processing circuit 510, causes the processing circuit 510 to perform one or more of the various functions and/or process steps described herein. For example, the storage medium 504 may include one or more of the code (e.g., operations) for receiving a signal 534, the code for generating SIR targets 536, the code for generating SIR values 538, the code for generating TPC commands 540, the code for generating a base SIRT 542, the code for determining a type of traffic 544, and the code for determining whether to generate SIRT 546.

The processing circuit 510 can thus provide the functionality of the TFPC component 406 of FIG. 4. For example, in some implementations the modules 520, 522, 524, 526, 528, 530, and 532 are the TFPC component 406. As another example, the modules 534, 536, 538, 540, 542, 544, and 546 can be executed to provide the functionality of the TFPC component 406.

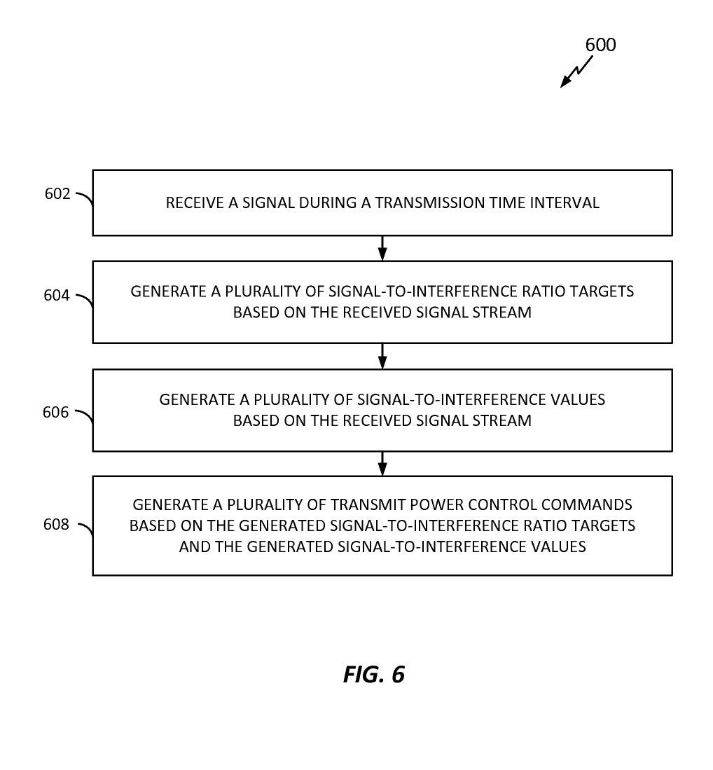

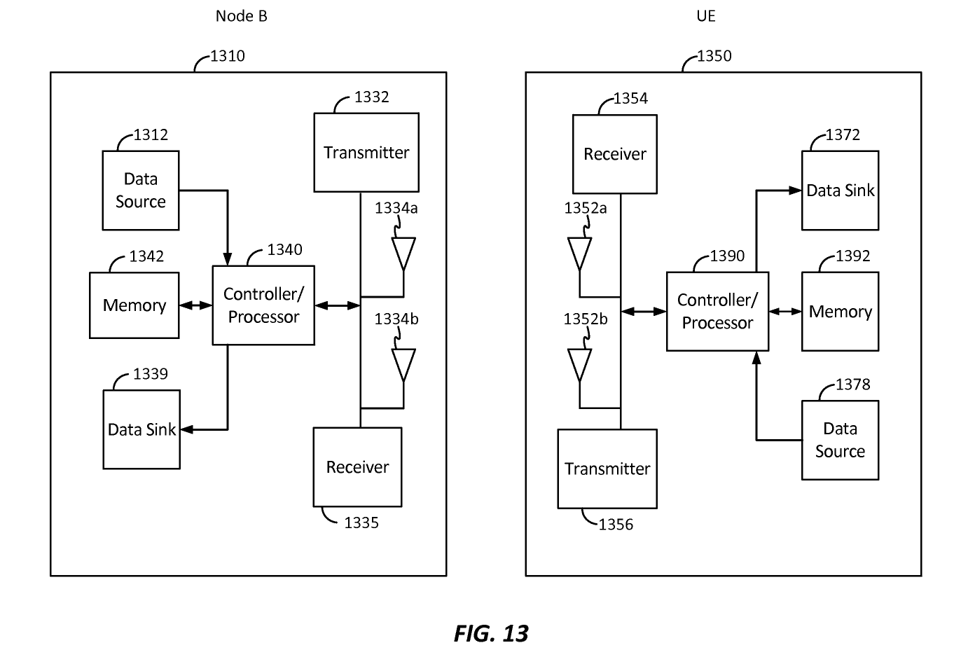

FIG. 6 illustrates a process 600 for power control in accordance with some aspects of the present disclosure. In some implementations, the process 600 is performed by inner loop power control based on the first algorithm described above. The process 600 may take place within the processing circuit 510, which may be located at a UE. In another aspect, the process 600 may be implemented by the UE 1350 illustrated in FIG. 13. Of course, in various aspects within the scope of the present disclosure, the process 600 may be implemented by any suitable apparatus capable of supporting power control.

In block 602, a signal is received during a transmission time interval. For example, a UE may receive signals on a downlink or a Node B may receive signals on an uplink. In some implementations, the module for receiving a signal 520 of FIG. 5 performs the operations of block 602. In some implementations, the code for receiving a signal 534 of FIG. 5 is executed to perform the operations of block 602.

In block 604, a plurality of signal-to-interference ratio targets are generated based on the received signal. For example, inner loop power control may generate the signal-to-interference ratio targets according to the first algorithm described above. In some implementations, the module for generating SIR targets 522 of FIG. 5 performs the operations of block 604. In some implementations, the code for generating SIR targets 536 of FIG. 5 is executed to perform the operations of block 604.

According to some aspects of the disclosure, the generation of the signal-to-interference ratio targets may comprise: generating a plurality of transport format estimates based on the received signal; and determining the signal-to-interference ratio targets based on the generated transport format estimates. According to some aspects of the disclosure, the generation of the signal-to-interference ratio targets may comprise, for each of a plurality of slots associated with the transmission time interval: estimating a transport format associated with the slot; and determining a signal-to-interference ratio target associated with the slot based on the estimated transport format associated with the slot.

In block 606, a plurality of signal-to-interference values are generated based on the received signal. For example, a signal-to-interference value may be generated for each slot of the transmission time interval. In some implementations, the module for generating SIR values 524 of FIG. 5 performs the operations of block 606. In some implementations, the code for generating SIR values 538 of FIG. 5 is executed to perform the operations of block 606.

In block 608, a plurality of transmit power control commands are generated based on the signal-to-interference ratio targets generated in block 604 and the signal-to-interference values generated in block 606. In some implementations, the module for generating TPC commands 526 of FIG. 5 performs the operations of block 608. In some implementations, the code for generating TPC commands 540 of FIG. 5 is executed to perform the operations of block 608.

According to some aspects of the disclosure, the generation of the transmit power control commands may comprise, for each of the slots associated with the transmission time interval, determining a transmit power control command based on the signal-to-interference ratio target associated with the slot. For example, the TPC bit for a slot may be based on comparison of the SIR measured for the slot with the SIRT for the slot.

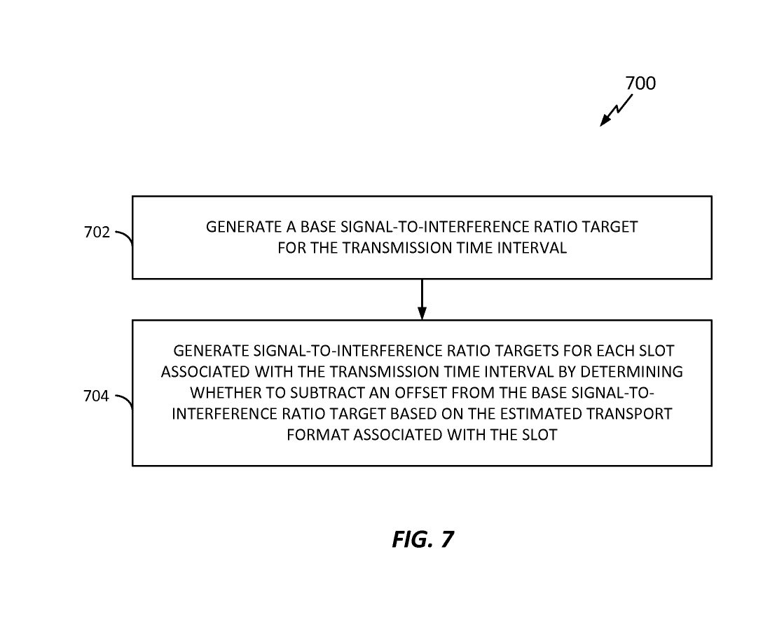

As mentioned above, an SIRT for ILPC may be generated as an offset from the SIRT for OLPC. FIG. 7 illustrates a process 700 for generating an SIRT in accordance with this aspect of the present disclosure. For example, in some implementations, the operations of block 604 of FIG. 6 include the process 700 whereby an SIRT for ILPC can be generated as an offset from a “base” (e.g., reference) SIRT for OLPC.

In block 702, a “base” (e.g., reference) signal-to-interference ratio target for a transmission time interval is generated. For example, after each TTI, OLPC may generate an SIRT to be used during the next TTI. In some implementations, the module for generating a base SIRT 528 of FIG. 5 performs the operations of block 702. In some implementations, the code for generating a base SIRT 542 of FIG. 5 is executed to perform the operations of block 702.

In block 704, signal-to-interference ratio targets are generated for each slot associated with the transmission time interval. In some implementations, the module for generating SIR targets 522 of FIG. 5 performs the operations of block 704. In some implementations, the code for generating SIR targets 536 of FIG. 5 is executed to perform the operations of block 704.

According to some aspects of the disclosure, the generation of each signal-to-interference ratio target involves determining whether to subtract an offset from the base signal-to-interference ratio target based on the estimated transport format associated with the slot. For example, if the transport format estimate for the slot is NULL or SIF, a corresponding offset is subtracted from the base signal-to-interference ratio target (e.g., SIRT_{OLPC}) to generate the signal-to-interference ratio target for the slot. Conversely, if the transport format estimate for the slot is FR, no offset is subtracted and the base signal-to-interference ratio target (e.g., SIRT_{OLPC}) is used for the slot in this case. Thus, according to some aspects of the disclosure, the determination of whether to subtract an offset from the base signal-to-interference ratio target may comprise: determining to subtract a first offset from the base signal-to-interference ratio target if the estimated transport format associated with the slot is a NULL transport format; determining to subtract a second offset from the base signal-to-interference ratio target if the estimated transport format associated with the slot is an SID transport format; and determining to not subtract any offset from the base signal-to-interference ratio target if the estimated transport format associated with the slot is an FR transport format.

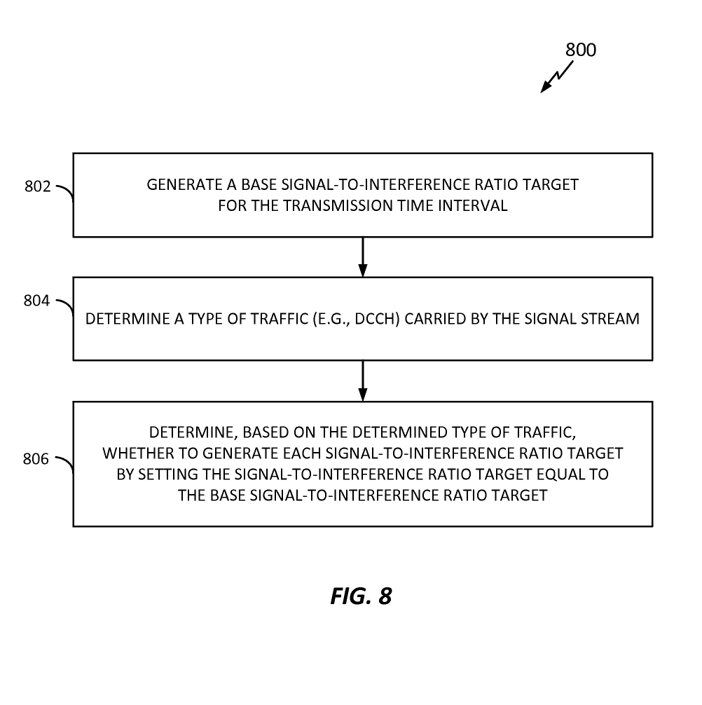

As mentioned above, a power control algorithm implemented in accordance with the teachings herein may take into account a type of traffic carried by a channel. FIG. 8 illustrates a process 800 for generating an SIRT in accordance with this aspect of the present disclosure. For example, in some implementations, the operations of block 604 of FIG. 6 include the process 800 whereby the generation of the SIRT can be based on traffic type.

In block 802, a base signal-to-interference ratio target for a transmission time interval is generated. This operation may be similar in some aspects to the operation of block 702 described above. In some implementations, the module for generating a base SIRT 528 of FIG. 5 performs the operations of block 802. In some implementations, the code for generating a base SIRT 542 of FIG. 5 is executed to perform the operations of block 802.

In block 804, a determination is made as to the type of traffic carried by a received signal. For example, a traffic analyzer may be invoked to determine whether the received signal carries DCCH or some other type of traffic of interest. In some implementations, the module for determining a type of traffic 530 of FIG. 5 performs the operations of block 804. In some implementations, the code for determining a type of traffic 544 of FIG. 5 is executed to perform the operations of block 804.

In block 806, based on the type of traffic determined at block 804, a determination is made as whether to generate each signal-to-interference ratio target by setting the signal-to-interference ratio target equal to the base signal-to-interference ratio target. For example, in the event DCCH is detected, it may be desirable to not reduce the signal-to-interference ratio target in an effort to ensure reliable transfer of this information. Thus, the signal-to-interference ratio target may be set equal to the base signal-to-interference ratio target in this case. In some implementations, the module for determining whether to generate SIRT 532 of FIG. 5 performs the operations of block 806. In some implementations, the code for determining whether to generate SIRT 546 of FIG. 5 is executed to perform the operations of block 806.

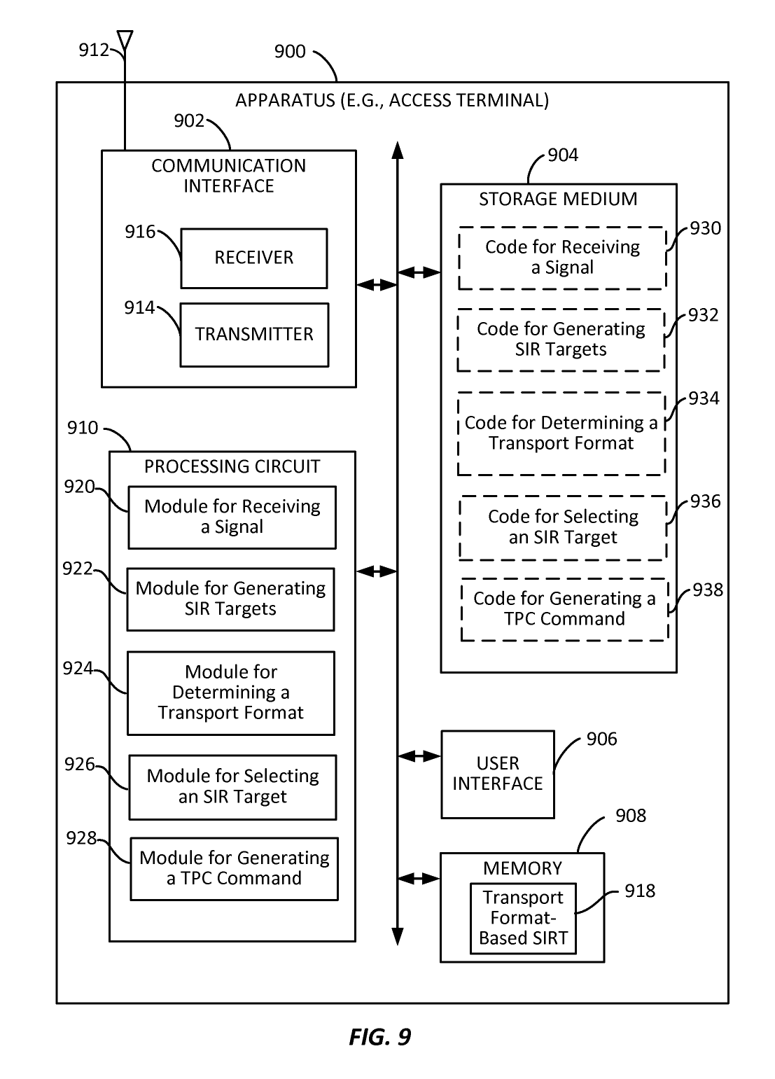

FIG. 9 is an illustration of an apparatus 900 (e.g., an access terminal) configured according to one or more aspects of the disclosure. The apparatus 900 includes a communication interface 902, a storage medium 904, a user interface 906, a memory 908, and a processing circuit 910. These components can be coupled to and/or placed in electrical communication with one another via a signaling bus or other suitable component. In particular, each of the communication interface 902, the storage medium 904, the user interface 906, and the memory 908 are coupled to and/or in electrical communication with the processing circuit 910.

The communication interface 902 may be adapted to facilitate wireless communication of the apparatus 900. For example, the communication interface 902 may include circuitry and/or programming adapted to facilitate the communication of information bi-directionally with respect to one or more communication devices in a network. The communication interface 902 may be coupled to one or more antennas 912 for wireless communication within a wireless communication system. The communication interface 902 can be configured with one or more standalone receivers and/or transmitters, as well as one or more transceivers. In the illustrated example, the communication interface 902 includes a transmitter 914 and a receiver 916.

The memory 908 may represent one or more memory devices. As indicated, the memory 908 may store transport format-based SIRT-related information 918 along with other information used by the apparatus 900. In some implementations, the memory 908 and the storage medium 904 are implemented as a common memory component. The memory 908 may also be used for storing data that is manipulated by the processing circuit 910 or some other component of the apparatus 900.

The processing circuit 910, as well as any of its modules 920-928, may be arranged to obtain, process and/or send data, control data access and storage, issue commands, and control other desired operations. The processing circuit 910, as well as any of its modules 920-928, may include circuitry configured to perform a desired function and/or implement desired programming provided by appropriate media. The processing circuit 910, as well as any of its modules 920-928, may be implemented and/or configured according to any of the examples of the processing circuit 510 and modules 520-532 described above.

According to at least one example of the apparatus 900, the processing circuit 910 may include one or more of a module for receiving a signal 920, a module for generating SIR targets 922, a module for determining a transport format 924, a module for selecting an SIR target 926, or a module for generating a TPC command 928.

The module for receiving a signal 920 may include circuitry and/or programming adapted to perform several functions relating to, for example, receiving data during a plurality of TTIs. One of these functions involves invoking a transfer of specific data from another component. For example, the receiver 916 of the apparatus 900 can be configured to monitor for signals from an access point. Another one of these functions involves acquiring the transferred data. For example, the module for receiving a signal 920 may decode the received signals to derive the data that is encoded in the signals. Another one of these functions involves storing the data for access by another component of the processing circuit 910 or some other component of the apparatus 900. For example, the module for receiving a signal 920 may store the data acquired in the previous function in a specified memory location in the memory 908. In some implementations, the programming referred to above comprises code for receiving a signal 930 stored on the storage medium 904.

The module for generating SIR targets 922 may include circuitry and/or programming adapted to perform several functions relating to, for example, generating a plurality of SIR targets for each TTI based on a received signal. One of these functions involves determining a block error rate associated with received data. For example, the CRC of received data may be checked. Another one of these functions involves calculating the SIRT based on the block error rate. For example, as discussed above, a higher error rate may result in a higher SIRT, and vice versa. As discussed herein, different SIRTs may be generated for different transport formats. Another one of these functions involves outputting an indication of each SIRT (e.g., storing the indication in a specified memory location). In some implementations, the programming referred to above comprises code for generating SIR targets 932 stored on the storage medium 904.

In addition, the module for determining a transport format 924 may include circuitry and/or programming adapted to perform several functions relating to, for example, determining a transport format associated with a TTI. For example, upon receipt of data from the receiver 916, the module for determining a transport format 924 may process the data to estimate the type of transport format associated with the data. Another one of these functions involves outputting an indication of the estimated transport format (e.g., storing the indication in a specified memory location). In some implementations, the programming referred to above comprises code for determining a transport format 934 stored on the storage medium 904.

The module for selecting an SIR target 926 may include circuitry and/or programming adapted to perform several functions relating to, for example, selecting one of a plurality of SIR targets for a TTI based on a transport format. One of these functions involves acquiring transport format information. For example, the module for selecting an SIR target 926 may obtain this information from the memory 908. Another one of these functions involves identifying an SIRT associated with the transport format information. Another one of these functions involves storing an indication of the selected SIRT. In some implementations, the programming referred to above comprises code for selecting an SIR target 936 stored on the storage medium 904.

Further, the module for generating a TPC command 928 may include circuitry and/or programming adapted to perform several functions relating to, for example, generating TPC commands based on a selected SIRT. One of these functions involves acquiring the SIRT and SIR values. For example, the module for generating a TPC command 928 may retrieve this information from the memory 908. Another one of these functions involves processing the acquired information to determine the TPC command to be issued. For example, an SIR value may be compared to the SIRT. Based on this comparison, a TPC command that indicates that transmit power should be increased or decreased may then be generated. Another one of these functions involves outputting the TPC command. For example, the TPC command may be sent to the transmitter 914 for transmission. In some implementations, the programming referred to above comprises code for generating a TPC command 938 stored on the storage medium 904.

The storage medium 904 may represent one or more processor-readable devices for storing programming, such as processor executable code or instructions (e.g., software, firmware), electronic data, databases, or other digital information. The storage medium 904 may be configured and/or implemented in a manner similar to the storage medium 504 described above.

The storage medium 904 may be coupled to the processing circuit 910 such that the processing circuit 910 can read information from, and write information to, the storage medium 904. That is, the storage medium 904 can be coupled to the processing circuit 910 so that the storage medium 904 is at least accessible by the processing circuit 910, including examples where the storage medium 904 is integral to the processing circuit 910 and/or examples where the storage medium 904 is separate from the processing circuit 910.

Like the storage medium 504, the storage medium 904 includes programming stored thereon. The programming stored by the storage medium 904, when executed by the processing circuit 910, causes the processing circuit 910 to perform one or more of the various decoding functions and/or process steps described herein. For example, the storage medium 904 may include one or more of the code (e.g., operations) for receiving a signal 930, the code for generating SIR targets 932, the code for determining a transport format 934, the code for selecting an SIR target 936, or the code for generating a TPC command 938.

Thus, according to one or more aspects of the present disclosure, the processing circuit 910 is adapted to perform (in conjunction with the storage medium 904) any or all of the decoding processes, functions, steps and/or routines for any or all of the apparatuses described herein. As used herein, the term “adapted” in relation to the processing circuit 910 may refer to the processing circuit 910 being one or more of configured, employed, implemented, and/or programmed (in conjunction with the storage medium 904) to perform a particular process, function, step and/or routine according to various features described herein.

The processing circuit 510 can thus provide the functionality of the TFPC component 406 of FIG. 4. For example, in some implementations, the modules 920, 922, 924, 926, and 928 are the TFPC component 406. As another example, the modules 930, 932, 934, 936, and 938 can be executed to provide the functionality of the TFPC component 406.

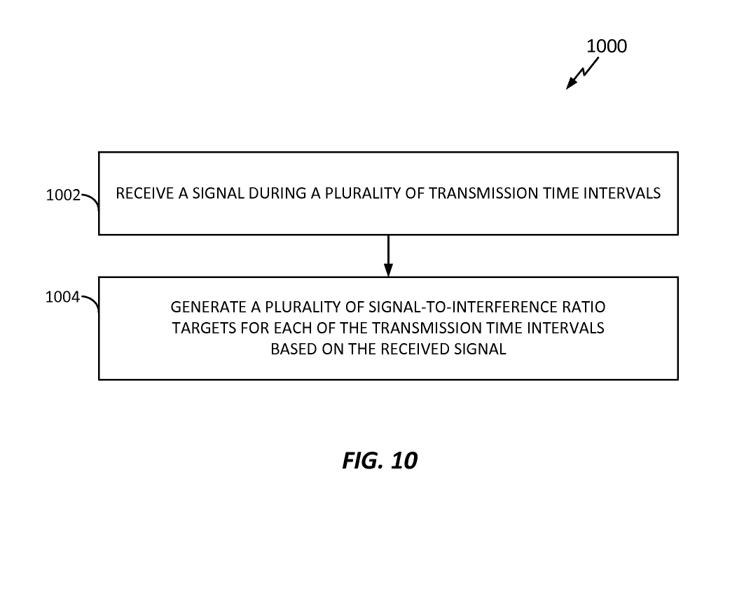

FIG. 10 illustrates another process 1000 for power control in accordance with some aspects of the present disclosure. In some implementations, the process 1000 is performed by outer loop power control based on the second algorithm described above. The process 1000 may take place within the processing circuit 910, which may be located at a UE. In another aspect, the process 1000 may be implemented by the UE 1350 illustrated in FIG. 13. Of course, in various aspects within the scope of the present disclosure, the process 1000 may be implemented by any suitable apparatus capable of supporting power control.

In block 1002, a signal is received during a plurality of transmission time intervals. For example, a UE may receive downlink signals from a serving Node B over a period of time. In some implementations, the module for receiving a signal 920 of FIG. 9 performs the operations of block 1002. In some implementations, the code for receiving a signal 930 of FIG. 9 is executed to perform the operations of block 1002.

In block 1004, a plurality of signal-to-interference ratio targets are generated for each of the transmission time intervals based on the received signal stream. Of note, this operation stands in contrast with a conventional OLPC scheme that only generates a single signal-to-interference ratio target per transmission time interval. In some implementations, the module for generating SIR targets 922 of FIG. 9 performs the operations of block 1004. In some implementations, the code for generating SIR targets 932 of FIG. 9 is executed to perform the operations of block 1004.

According to some aspects of the disclosure, the signal-to-interference ratio targets generated for a given transmission time interval are associated with different transport formats. For example, for a given transmission time interval, the signal-to-interference ratio targets may comprise: a first signal-to-interference ratio target associated with a NULL transport format; a second signal-to-interference ratio target associated with an SID transport format; and a third signal-to-interference ratio target associated with an FR transport format.

According to some aspects of the disclosure, the generation of the signal-to-interference ratio targets may comprise, for each of a plurality of transport formats: error checking traffic associated with the transport format; and adjusting a signal-to-interference ratio target associated with the transport format based on the error checking. For example, the signal-to-interference ratio target for a given transport format may be adjusted based on the results of a CRC check performed on a transmission time interval associated with that transport format.

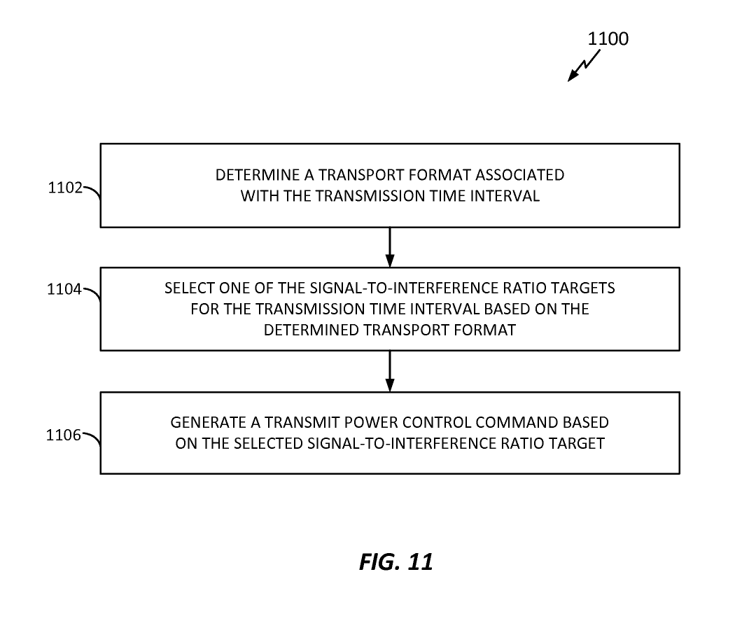

An ILPC algorithm may use the SIRTs generated according to the process 1000. FIG. 11 illustrates a process 1100 for generating TPC commands in accordance with this aspect of the present disclosure. For example, in some implementations, the SIRTs generated at block 1004 of FIG. 10 are used in the process 1100 (e.g., at block 1104) to generate a TPC command.

In block 1102, a transport format associated with a given transmission time interval is determined (e.g., identified). For example, a determination may be made, for each of a plurality of slots associated with the transmission time interval, as to the transport format associated with the slot. In some implementations, the module for determining a transport format 924 of FIG. 9 performs the operations of block 1102. In some implementations, the code for determining a transport format 934 of FIG. 9 is executed to perform the operations of block 1102.

In block 1104, one of the signal-to-interference ratio targets for the transmission time interval is selected based on the transport format determined at block 1102. According to some aspects of the disclosure, this may involve selecting, for each of the slots associated with the transmission time interval, one of the signal-to-interference ratio targets for the transmission time interval based on the determined transport format for the slot. For example, SIRT_{FR} may be selected for a slot at block 1104 if the transport format for the slot is FR. In some implementations, the module for selecting an SIR target 926 of FIG. 9 performs the operations of block 1104. In some implementations, the code for selecting an SIR target 936 of FIG. 9 is executed to perform the operations of block 1104.

In block 1106, a transmit power control command is generated based on the signal-to-interference ratio target selected at block 1104. According to some aspects of the disclosure, this may involve generating, for each of the slots associated with the transmission time interval, a transmit power control command based on the selected signal-to-interference ratio target for the slot. For example, a TPC bit for a slot with transport format FR may be generated by comparing the measure SIR for the slot with SIRT_{FR}. In some implementations, the module for generating a TPC command 928 of FIG. 9 performs the operations of block 1106. In some implementations, the code for generating a TPC command 938 of FIG. 9 is executed to perform the operations of block 1106.

The teachings herein may be implemented in various ways in different embodiments. Several examples follow.

While an example implementation dealing with BTFD was described above for purposes of illustration, the disclosed concepts are not limited to the BTFD scenario. For example, a node operating in transport format combination indicator (TFCI) mode can detect the transport format by early decoding of the TFCI from the received slots.

While an example implementation dealing with single rate AMR was described above for purposes of illustration, the disclosed concepts are not limited to the single rate AMR scenario. For example, the teachings herein may be equally applicable to multi rate AMR. Here, either multiple δ values are maintained (e.g., for the first algorithm) or multiple SIRTs are maintained for each transport format (e.g., for the second algorithm).

While an example implementation dealing with downlink power control was described above for purposes of illustration, the disclosed concepts are not limited to the downlink scenario. For example, the teachings herein may be equally applicable to uplink power control (at the network (e.g., Boa) that is transmitting voice data to the UE) or power control on other types of links (e.g., peer-to-peer links).

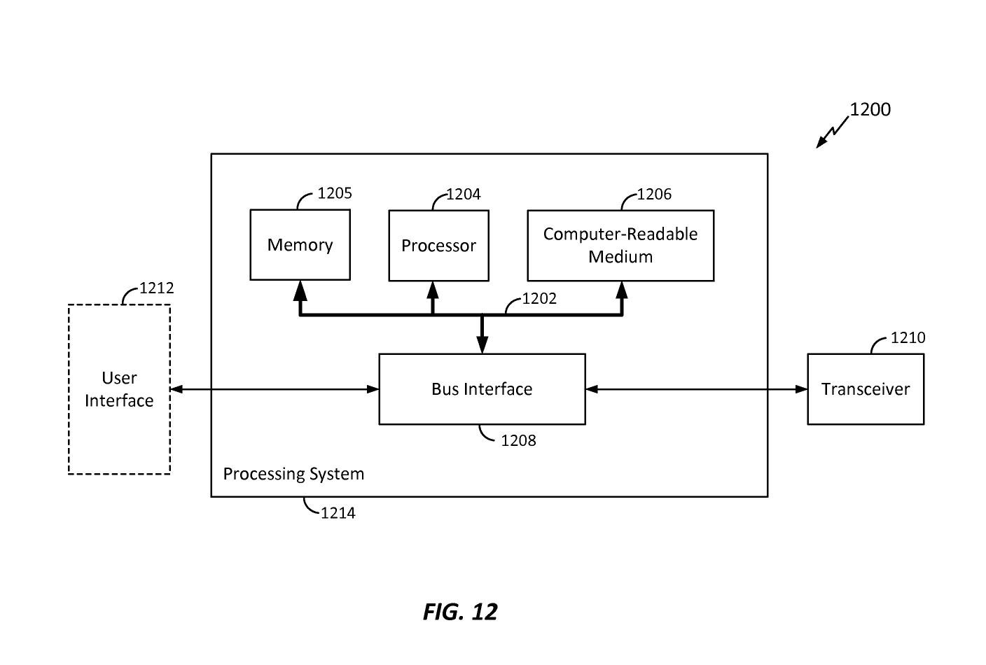

FIG. 12 is a block diagram illustrating an example of a hardware implementation for an apparatus 1200 employing a processing system 1214. In this example, the processing system 1214 may be implemented with a bus architecture, represented generally by the bus 1202. The bus 1202 may include any number of interconnecting buses and bridges depending on the specific application of the processing system 1214 and the overall design constraints. The bus 1202 links together various circuits including one or more processors, represented generally by the processor 1204, a memory 1205, and computer-readable media, represented generally by the computer-readable medium 1206. The bus 1202 may also link various other circuits such as timing sources, peripherals, voltage regulators, and power management circuits, which are well known in the art, and therefore, will not be described any further. A bus interface 128 provides an interface between the bus 1202 and a transceiver 1210. The transceiver 1210 provides a means for communicating with various other apparatus over a transmission medium. Depending upon the nature of the apparatus, a user interface 1212 (e.g., keypad, display, speaker, microphone, joystick) may also be provided.

The processor 1204 is responsible for managing the bus 1202 and general processing, including the execution of software stored on the computer-readable medium 1206. The software, when executed by the processor 1204, causes the processing system 1214 to perform the various functions described infra for any particular apparatus. The computer-readable medium 1206 may also be used for storing data that is manipulated by the processor 1204 when executing software.

FIG. 13 is a block diagram of an exemplary Node B 1310 in communication with an exemplary UE 1350, where the Node B 1310 may be the Node B 208 in FIG. 2, and the UE 1350 may be the UE 210 in FIG. 2. In the downlink communication, a controller or processor 1340 may receive data from a data source 1312. Channel estimates may be used by a controller/processor 1340 to determine the coding, modulation, spreading, and/or scrambling schemes for the transmit processor 1320. These channel estimates may be derived from a reference signal transmitted by the UE 1350 or from feedback from the UE 1350. A transmitter 1332 may provide various signal conditioning functions including amplifying, filtering, and modulating frames onto a carrier for downlink transmission over a wireless medium through one or more antennas 1334. The antennas 1334 may include one or more antennas, for example, including beam steering bidirectional adaptive antenna arrays, MIMO arrays, or any other suitable transmission/reception technologies.

At the UE 1350, a receiver 1354 receives the downlink transmission through one or more antennas 1352 and processes the transmission to recover the information modulated onto the carrier. The information recovered by the receiver 1354 is provided to a controller/processor 1390. The processor 1390 descrambles and despreads the symbols, and determines the most likely signal constellation points transmitted by the Node B 1310 based on the modulation scheme. These soft decisions may be based on channel estimates computed by the processor 1390. The soft decisions are then decoded and deinterleaved to recover the data, control, and reference signals. The CRC codes are then checked to determine whether the frames were successfully decoded. The data carried by the successfully decoded frames will then be provided to a data sink 1372, which represents applications running in the UE 1350 and/or various user interfaces (e.g., display). Control signals carried by successfully decoded frames will be provided to a controller/processor 1390. When frames are unsuccessfully decoded, the controller/processor 1390 may also use an acknowledgement (ACK) and/or negative acknowledgement (NACK) protocol to support retransmission requests for those frames.

In the uplink, data from a data source 1378 and control signals from the controller/processor 1390 are provided. The data source 1378 may represent applications running in the UE 1350 and various user interfaces (e.g., keyboard). Similar to the functionality described in connection with the downlink transmission by the Node B 1310, the processor 1390 provides various signal processing functions including CRC codes, coding and interleaving to facilitate FEC, mapping to signal constellations, spreading with OVSFs, and scrambling to produce a series of symbols. Channel estimates, derived by the processor 1390 from a reference signal transmitted by the Node B 1310 or from feedback contained in a midamble transmitted by the Node B 1310, may be used to select the appropriate coding, modulation, spreading, and/or scrambling schemes. The symbols produced by the processor 1390 will be utilized to create a frame structure. The processor 1390 creates this frame structure by multiplexing the symbols with additional information, resulting in a series of frames. The frames are then provided to a transmitter 1356, which provides various signal conditioning functions including amplification, filtering, and modulating the frames onto a carrier for uplink transmission over the wireless medium through the one or more antennas 1352.

The uplink transmission is processed at the Node B 1310 in a manner similar to that described in connection with the receiver function at the UE 1350. A receiver 1335 receives the uplink transmission through the one or more antennas 1334 and processes the transmission to recover the information modulated onto the carrier. The information recovered by the receiver 1335 is provided to the processor 1340, which parses each frame. The processor 1340 performs the inverse of the processing performed by the processor 1390 in the UE 1350. The data and control signals carried by the successfully decoded frames may then be provided to a data sink 1339. If some of the frames were unsuccessfully decoded by the receive processor, the controller/processor 1340 may also use an acknowledgement (ACK) and/or negative acknowledgement (NACK) protocol to support retransmission requests for those frames.

The controller/processors 1340 and 1390 may be used to direct the operation at the Node B 1310 and the UE 1350, respectively. For example, the controller/processors 1340 and 1390 may provide various functions including timing, peripheral interfaces, voltage regulation, power management, and other control functions. The computer readable media of memories 1342 and 1392 may store data and software for the Node B 1310 and the UE 1350, respectively.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for transmit power control, comprising:
receiving a signal during a transmission time interval;
generating a plurality of signal-to-interference ratio targets based on the received signal;
generating a plurality of signal-to-interference values based on the received signal; and
generating a plurality of transmit power control commands based on the generated signal-to-interference ratio targets and the generated signal-to-interference values.

2. The method of claim 1, wherein the generation of the signal-to-interference ratio targets comprises:
generating a plurality of transport format estimates based on the received signal; and
determining the signal-to-interference ratio targets based on the generated transport format estimates.

3. The method of claim 1, wherein the generation of the signal-to-interference ratio targets comprises, for each of a plurality of slots associated with the transmission time interval:
estimating a transport format associated with the slot; and
determining a signal-to-interference ratio target associated with the slot based on the estimated transport format associated with the slot.

4. The method of claim 3, wherein the generation of the transmit power control commands comprises, for each of the slots associated with the transmission time interval, determining a transmit power control command based on the signal-to-interference ratio target associated with the slot.

5. The method of claim 3, further comprising:
generating a base signal-to-interference ratio target for the transmission time interval,
wherein the generation of each of the signal-to-interference ratio targets comprises, for each of the slots associated with the transmission time interval, determining whether to subtract an offset from the base signal-to-interference ratio target based on the estimated transport format associated with the slot.

6. The method of claim 5, further comprising computing the offset based on rate matched symbols across different transport formats of at least one transport channel.

7. The method of claim 5, wherein:
the generation of the base signal-to-interference ratio target is performed by outer loop power control; and
the generation of the plurality of signal-to-interference ratio targets is performed by inner loop power control.

8. The method of claim 7, further comprising discontinuing the generation of the plurality of signal-to-interference ratio targets by the inner loop power control if a block error rate for a particular transport format exceeds a boundary measured over a defined period of time.

9. The method of claim 7, further comprising triggering adaptation of the signal-to-interference ratio targets by the inner loop power control if a block error rate for a particular transport format exceeds a boundary measured over a defined period of time.

10. The method of claim 7, wherein the generation of the base signal-to-interference ratio target by the outer loop power control is based on rate matched symbols across different transport formats of at least one transport channel.

11. The method of claim 5, wherein the determination of whether to subtract an offset from the base signal-to-interference ratio target comprises:
determining to subtract a first offset from the base signal-to-interference ratio target if the estimated transport format associated with the slot is a NULL transport format;
determining to subtract a second offset from the base signal-to-interference ratio target if the estimated transport format associated with the slot is a silent mode (SID) transport format; and
determining to not subtract any offset from the base signal-to-interference ratio target if the estimated transport format associated with the slot is a full rate (FR) transport format.

12. The method of claim 1, further comprising:
generating a base signal-to-interference ratio target for the transmission time interval;
determining a type of traffic carried by the signal; and
determining, based on the determined type of traffic, whether to generate each of the signal-to-interference ratio targets by setting the signal-to-interference ratio target equal to the base signal-to-interference ratio target.

13. An apparatus for transmit power control, comprising:
means for receiving a signal during a transmission time interval;
means for generating a plurality of signal-to-interference ratio targets based on the received signal;
means for generating a plurality of signal-to-interference values based on the received signal; and
means for generating a plurality of transmit power control commands based on the generated signal-to-interference ratio targets and the generated signal-to-interference values.

14. The apparatus of claim 13, wherein the generation of the signal-to-interference ratio targets comprises:
generating a plurality of transport format estimates based on the received signal; and
determining the signal-to-interference ratio targets based on the generated transport format estimates.

15. The apparatus of claim 13, wherein the generation of the signal-to-interference ratio targets comprises, for each of a plurality of slots associated with the transmission time interval:
estimating a transport format associated with the slot; and
determining a signal-to-interference ratio target associated with the slot based on the estimated transport format associated with the slot.

16. The apparatus of claim 15, wherein the generation of the transmit power control commands comprises, for each of the slots associated with the transmission time interval, determining a transmit power control command based on the signal-to-interference ratio target associated with the slot.

17. The apparatus of claim 15, further comprising:
means for generating a base signal-to-interference ratio target for the transmission time interval,
wherein the generation of each of the signal-to-interference ratio targets comprises, for each of the slots associated with the transmission time interval, determining whether to subtract an offset from the base signal-to-interference ratio target based on the estimated transport format associated with the slot.

18. The apparatus of claim 17, wherein the means for generating a plurality of signal-to-interference ratio targets is configured to compute the offset based on rate matched symbols across different transport formats of at least one transport channel.

19. The apparatus of claim 17, wherein:
the generation of the base signal-to-interference ratio target is performed by outer loop power control; and
the generation of the plurality of signal-to-interference ratio targets is performed by inner loop power control.

20. The apparatus of claim 19, wherein the means for generating a plurality of signal-to-interference ratio targets is configured to discontinue the generation of the plurality of signal-to-interference ratio targets by the inner loop power control if a block error rate for a particular transport format exceeds a boundary measured over a defined period of time.

21. The apparatus of claim 19, wherein the means for generating a plurality of signal-to-interference ratio targets is configured to trigger adaptation of the signal-to-interference ratio targets by the inner loop power control if a block error rate for a particular transport format exceeds a boundary measured over a defined period of time.

22. The apparatus of claim 19, wherein the generation of the base signal-to-interference ratio target by the outer loop power control is based on rate matched symbols across different transport formats of at least one transport channel.

23. The apparatus of claim 17, wherein the determination of whether to subtract an offset from the base signal-to-interference ratio target comprises:
determining to subtract a first offset from the base signal-to-interference ratio target if the estimated transport format associated with the slot is a NULL transport format;
determining to subtract a second offset from the base signal-to-interference ratio target if the estimated transport format associated with the slot is a silent mode (SID) transport format; and
determining to not subtract any offset from the base signal-to-interference ratio target if the estimated transport format associated with the slot is a full rate (FR) transport format.

24. The apparatus of claim 13, further comprising:
means for generating a base signal-to-interference ratio target for the transmission time interval;
means for determining a type of traffic carried by the signal; and
means for determining, based on the determined type of traffic, whether to generate each of the signal-to-interference ratio targets by setting the signal-to-interference ratio target equal to the base signal-to-interference ratio target.

25. An apparatus for transmit power control, comprising:
at least one processor; and
a memory coupled to the at least one processor,
wherein the at least one processor is configured to:
receive a signal during a transmission time interval;
generate a plurality of signal-to-interference ratio targets based on the received signal;
generate a plurality of signal-to-interference values based on the received signal; and
generate a plurality of transmit power control commands based on the generated signal-to-interference ratio targets and the generated signal-to-interference values.

26. The apparatus of claim 25, wherein the generation of the signal-to-interference ratio targets comprises:
generating a plurality of transport format estimates based on the received signal; and
determining the signal-to-interference ratio targets based on the generated transport format estimates.

27. The apparatus of claim 25, wherein the generation of the signal-to-interference ratio targets comprises, for each of a plurality of slots associated with the transmission time interval:
estimating a transport format associated with the slot; and
determining a signal-to-interference ratio target associated with the slot based on the estimated transport format associated with the slot.

28. The apparatus of claim 27, wherein the generation of the transmit power control commands comprises, for each of the slots associated with the transmission time interval, determining a transmit power control command based on the signal-to-interference ratio target associated with the slot.

29. The apparatus of claim 25, wherein the at least one processor is further configured to:
generate a base signal-to-interference ratio target for the transmission time interval;
determine a type of traffic carried by the signal; and
determine, based on the determined type of traffic, whether to generate each of the signal-to-interference ratio targets by setting the signal-to-interference ratio target equal to the base signal-to-interference ratio target.

30. A non-transitory computer-readable medium comprising instructions for causing a computer to:
receive a signal during a transmission time interval;
generate a plurality of signal-to-interference ratio targets based on the received signal;
generate a plurality of signal-to-interference values based on the received signal; and
generate a plurality of transmit power control commands based on the generated signal-to-interference ratio targets and the generated signal-to-interference values.
